(19) United States
(12) Patent Application Publication
(10) Pub. No.: US 2002/0123334 A1
(43) Pub. Date: Sep. 5, 2002

(54) Systems, methods and computer program products for dynamically inserting content into web documents for display by client devices

(76) Inventors: Dana Borger, Cary, NC (US); Steve Cox, Durham, NC (US); Tom Gordon, New York, NY (US); David Spitz, Raleigh, NC (US); Matthew Squire, Raleigh, NC (US); Jay Thrash, Raleigh, NC (US)

Correspondence Address: Needham J. Boddie, II, Myers, Bigel Sibley & Sajovec, Post Office Box 37428, Raleigh, NC, 27627, US

(21) Appl. No.: 09/799,194

(22) Filed: Mar. 5, 2001

Related U.S. Application Data
(60) Provisional application No. 60/202,774, filed on May 9, 2000.
(60) Provisional application No. 60/220,559, filed on Jul. 25, 2000.

(51) Int. Cl. H04M 3/42

(52) U.S. Cl. 455/419; 455/414

(57) ABSTRACT

Systems, methods, and computer program produces for dynamically inserting content into Web documents for display by client devices are provided. User requests for Web documents are sent from a client device to a first server. In response to receiving the user request, the first server sends a request to a second server for content to be included within a requested Web document. The second server sends content having a format specified by the markup tag to the first server. The first server then serves a requested Web document with the content included therewithin at the identified location to a client device.

### RELATED APPLICATIONS

This application claims the benefit of U.S. Provisional Application No. 60/202,774, filed May 9, 2000, and U.S. Provisional Application No. 60/220,559, filed Jul. 25, 2000.

### FIELD OF THE INVENTION

The present invention relates generally to Web documents and, more particularly, to Web document content.

### BACKGROUND OF THE INVENTION

The Internet has gained broad recognition and acceptance as a viable medium for communicating and for conducting business. The World-Wide Web (Web) was created in the early 1990's, and is comprised of server-hosting computers (Web servers) connected to the Internet that: have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device. While HTTP and Web pages are the prevalent forms for the Web, the Web itself refers to a wide range of protocols including Secure Hypertext Transfer Protocol (HTTPS) and File Transfer Protocol (FTP), and Web content formats including plain text, HyperText Markup Language (HTML), Extensible Markup Language (XML), as well as image formats such as Graphics Interchange Format (GIF) and Joint Photographic Experts Group (JPEG).

A Web site is conventionally a related collection of Web files that includes a beginning file called a “home” page. From the home page, a visitor can access other files and applications at a Web site. A large Web site may utilize a number of servers, which may or may not be different and may or may not be geographically-dispersed. For example, the Web site of the International Business Machines Corporation (www.ibm.com) consists of thousands of Web pages and files spread out over multiple Web servers in locations world-wide.

A Web server (also referred to as an HTTP server) is a computer program that utilizes HTTP to serve files that form Web pages to Web clients. Exemplary Web servers include International Business Machines Corporation's family of Lotus Domino® servers and the Apache server (available from www.apache.org). A Web client is a requesting program that also utilizes HTTP. A browser is an exemplary Web client for use in requesting Web pages and files from Web servers. A Web server waits for a Web client, such as a browser, to open a connection and to request a specific web page or application. The Web server then sends a copy of the requested item to the Web client, closes the connection with the Web client, and waits for the next connection.

HTTP allows a browser to request a specific item, which a Web server then returns and the browser renders. To ensure that browsers and Web servers can interoperate unambiguously, HTTP defines the exact format of requests (HTTP requests) sent from a browser to a Web server as well as the format of responses (HTTP responses) that the Web server returns to the browser. Exemplary browsers include Netscape Navigators® (America Online, Inc., Dulles, Va.) and Internet Explorer® (Microsoft Corporation, Redmond, Wash.). Browsers typically provide a graphical user interface for retrieving and viewing Web pages, applications, and other resources served by Web servers.

With the increasing mobility of today's society, the demand for wireless communications devices has also increased. Many new wireless communications devices, such as personal digital assistants (PDAs), hand-held computers, and cellular telephones are gaining access to the Internet and/or to intranets as client devices. Unfortunately, the capabilities of wireless communications devices to receive, process, store and display Internet content may vary. For example, wireless communications devices typically have displays that are small in size compared with desktop computer displays. As a result, content portions of a Web page, such as images and rendered HTML that may be otherwise displayable on a desktop computer display, may not be displayable on a wireless communications device display unless some modifications to the images and/or text (i.e., the content) are made. For example, a desktop computer display having an array of 1024 pixels by 768 pixels may be able to display a large (e.g., 2 megabyte), 24 bit per pixel color image. A wireless communications device with a display having an array of 120 pixels by 120 pixels, and with the ability to display only about 3 bits per pixel, may ignore much of the image data. As a result the image may not be displayed properly, if at all, via the wireless communications device display unless the size of the image is transformed to the wireless communications device's capabilities. Furthermore, some wireless communications devices may not be capable of displaying certain image file types such as JPEG or GIF.

Text fonts and sizes within Web content may also need to be changed to permit the display thereof within a wireless communications device display. Furthermore, common HTML features such as frames and tables may not be displayable by wireless communications devices. Data within frames and tables may need to be removed and/or reformatted into other configurations for proper display. In addition, performance limitations of wireless communications devices, such as memory size and connection bandwidth, may also require changes to Web page content for proper display thereof via a wireless communications device.

It is known to take Web content that may not be properly displayable via a wireless communications device and “tailor” the Web content into a format that is displayable. For example, large, high resolution, color images can be transformed into small, black and white images that can be displayed within small, low resolution displays. The tailoring of video, images, audio and text for display within a client device typically is referred to as “transcoding.” Web content transcoding is typically performed by a transcoding proxy associated with a Web server. Products for transcoding Web content for display by a requesting client device are known. An exemplary transcoding product is “Cocoon” available from the Apache Server Foundation at http://java.apache.org.

To perform Web content transcoding, a Web server and/or transcoding proxy typically needs to know something about a client device making an HTTP request. As is known to those of skill in the art, HTTP headers accompany HTTP requests to a Web server. An HTTP header typically provides information about a requesting client device and browser. Exemplary information provided within an HTTP header may include the size of a client device display, whether a client device display is a color display or a monochromatic display, an identification of the client device browser, and an identification of the client device operating system.

Wireless communications devices with various browsers and configurations are being developed and introduced to market at a rapid pace. Given the variety of new wireless communications devices and protocols under which they operate, it may be difficult for Web content publishers to tailor content so as to be adequately displayable within many different devices.

As the Web has evolved into a viable commercial medium, advertising has become an important source of revenue for many commercial entities. Web pages served from commercial Web sites often utilize advertising to promote various goods and services. On-line advertising via the Internet conventionally involves the use of banners within Web pages. A banner conventionally is an advertisement in the form of a graphic image of a designated pixel size and byte size limit that typically runs across a Web page or is positioned in a margin or other space reserved for ads. FIG. 1 illustrates an exemplary Web page 10 containing various content objects 11, including a “banner” advertisement 12.

In virtually any type of advertising, it is considered highly desirable to target advertisements to individual customers, rather than to broadcast advertisements in general. With respect to the Internet, it is considered necessary that advertisements be rotated and managed independently from content in order to facilitate targeted marketing. As such, various methods of targeting advertisements to on-line users, independently from content, are known. See for example, U.S. Pat. No. 5,948,061 to Merriman et al.

Certain procedures have become the accepted standards for delivering advertisements to users accessing the Internet via traditional wireline based systems. For example, FIG. 2 schematically illustrates a conventional procedure for delivering an advertising banner to a user independently from requested content. A user, via a browser executing on a client device 15, sends a request for content 16 to a Web server 17 of a content provider (referred to as a Content Provider Server). In response to the request, the Content Provider Server 17 sends a reply 18 to the user's browser that contains content having space for display of an advertising banner. Within the content of the reply 183 is a reference (e.g., a uniform resource locator (URL)) to an advertising server. The user's browser requests this reference as a continuation of the download process.

The browser sends a request 19 to the advertising server 20. In response to the request, the advertising server 20 sends a reply 21 to the user's browser that includes another redirect command that informs the user's browser to send a request for a particular advertisement (e.g., an image file) to a media server 22. In response to this redirect command, the browser sends a request 23 to the media server 22 for the specified image file. In response to the request 23, the media server 22 sends the specified image file in a response 24 to the browser which inserts the image file within the space in the originally requested content.

Third party ad serving refers to the process by which two or more ad servers are used to serve an advertisement. The situation is often used when a content provider (“publisher”) has one ad serving solution (i.e., a Web server-independent service/product used by a content provider for including advertisements within content), and an advertiser has another ad serving solution. In such situations, the normal operation is as follows. The publisher ad server receives an initial ad request from a user's browser and selects an advertisement. This advertisement may in fact be a reference (URL) to another ad server (possibly owned or operated by the advertiser). The publisher ad server returns a redirect command to the user's browser directing the browser to this second ad server. The user's browser follows the redirect command to the second ad server and operations proceed according to conventional ad serving.

As is understood by those of skill in the art, an important component of conventional third-party ad serving is that multiple ad servers must be able to account for each user request. This is accomplished by having ad servers return references to other ad servers instead of actual advertisements.

There are currently no standards for delivering advertising content to users accessing the Internet via wireless communications. In addition, conventional ad serving technologies may not be compatible with many wireless devices. Moreover, wireless devices have different media formats, display abilities, and bandwidth capabilities/requirements. Additionally, wireless devices may use markup languages that do not support many of the HTML structures used in standard Internet advertising, such as IFrames, ILayers, and the like.

Accordingly, there is a need for ad serving procedures that are compatible with the new generation of wireless devices. These new procedures must be able to deliver ads, coupons, promotions, and the like to all forms of phones, PDAs, pagers, both existing and future.

### SUMMARY OF THE INVENTION

In view of the above, embodiments of the present invention provide systems, methods, and computer program products that can dynamically insert content into Web documents for display by wireless client devices. According to embodiments of the present invention, a user sends a request for a Web document from a wireless client device to a first server (e.g., a Web server), via a communications network (e.g., the Internet, an intranet, etc.). In response to receiving the user request, the first server sends a request to a second server (e.g., a third party ad server) for additional content (e.g., an advertisement, such as an image and/or text) to be included within the requested Web document. The location of the additional content is identified within the Web document by markup tags. Additional information, such as format of the content, may be specified by the markup tags as well.

The content request sent to the second server may include any information that was received by the first server with the user request including, but not limited to, user information and content format information. A user request may include information contained within a cookie stored within a user's wireless client device. In addition, a user request may include information contained within HTTP headers associated with the user request. The second server may select content for inclusion within the Web document based upon user information accompanying the content request.

Content selected by the second server for inclusion with the Web document may not have the format specified by the markup tags within the Web document. According to embodiments of the present invention, the second server may be configured to transcode the content to the format specified by the markup tags. The second server sends content having a format specified by the markup tags to the first server. The first server then serves the Web document to the wireless client device with the additional content included therewithin at the identified location.

According to additional embodiments of the present invention, a user sends a request for a Web document from a wireless client device to a first server, via a communications network. In response to receiving the user request, the first server sends a request to a second server for a first content portion (e.g., an advertisement, such as an image and/or text) to be included within the requested Web document. The location of the first content portion is identified within the Web document by a first markup tag (or by multiple first markup tags). In addition, the format of the first content portion is specified by the first markup tag.

In response to receiving the request for the first content portion, the second server selects a first content portion having a format specified by the first markup tag. If a first content portion does not have a format specified by the first markup tag, a first content portion may be transcoded to the format specified by the first markup tag.

The second server sends a request to a third server for a second content portion to be included within the first content portion at a location identified within the first content portion by a second markup tag (or by multiple second markup tags). In response to receiving the request for the second content portion, the third server selects a second content portion having a format specified by the second markup tag.

The third server then sends the second content portion to the second server. The second server sends the first content portion with the second content portion included therewithin to the first server. The first server then serves the Web document to the wireless client device with the first and second content portions included therewithin at the identified location.

Although the preceding description was limited to the case of three servers, embodiments of the present invention may involve a chain of servers of arbitrary length, where each server takes a request, selects some content locally, determines that a request to another third party server is required, retrieves content from that third party server, includes it with the locally selected content, and responds to the original inbound request.

Embodiments of the present invention can be advantageous because rich, dynamic content, such as advertising, can be inserted into static portions of Web documents and can adhere to syntax conventions of Web documents. Embodiments of the present invention can allow the same content to be targeted to a wide array of wireless communications devices, even though each device may use a different and/or specialized document format for displaying data. In addition, latency effects associated with conventional delivery of advertising content to client devices (i.e., via one or more client. redirects to remote servers) can be avoided via embodiments of the present invention because various advertising content requests are performed by servers. The benefits of this latency reduction are readily apparent when the user access technology (e.g., wireless) is slow, because server-server connections are generally faster and more reliable than user-server connections.

### BRIEF DESCRIPTION OF THE DRAWINGS

FIG. 1 illustrates an exemplary Web document. containing various content objects, including a “banner” advertisement.

FIG. 2 schematically illustrates a conventional procedure for delivering advertisements to a user's client device.

FIG. 3 is a flowchart of operations for dynamically inserting content into Web documents for display by wireless client devices, according to embodiments of the present invention.

FIGS. 4A-4F illustrate exemplary markup tags for various dynamic Web server technologies that may be utilized in accordance with embodiments of the present invention.

FIG. 5 is a block diagram representing systems, methods and/or computer program products for implementing operations of FIG. 3 to dynamically insert content into Web documents for display by wireless client devices, according to embodiments of the present invention.

FIG. 6 illustrates an exemplary Web document (in markup language format) that contains a plurality of markup tags that indicate the location and format of additional content to be included within the Web document.

FIG. 7 illustrates the Web document of FIG. 6 after additional content has been dynamically inserted at the indicated location.

FIG. 8 is a flowchart of operations for dynamically inserting content into Web documents for display by a wireless client device, according to additional embodiments of the present invention.

FIG. 9 is a block diagram representing systems, methods and/or computer program products for implementing operations of FIG. 8 for dynamically inserting content into Web documents for display by wireless client devices, according to embodiments of the present invention.

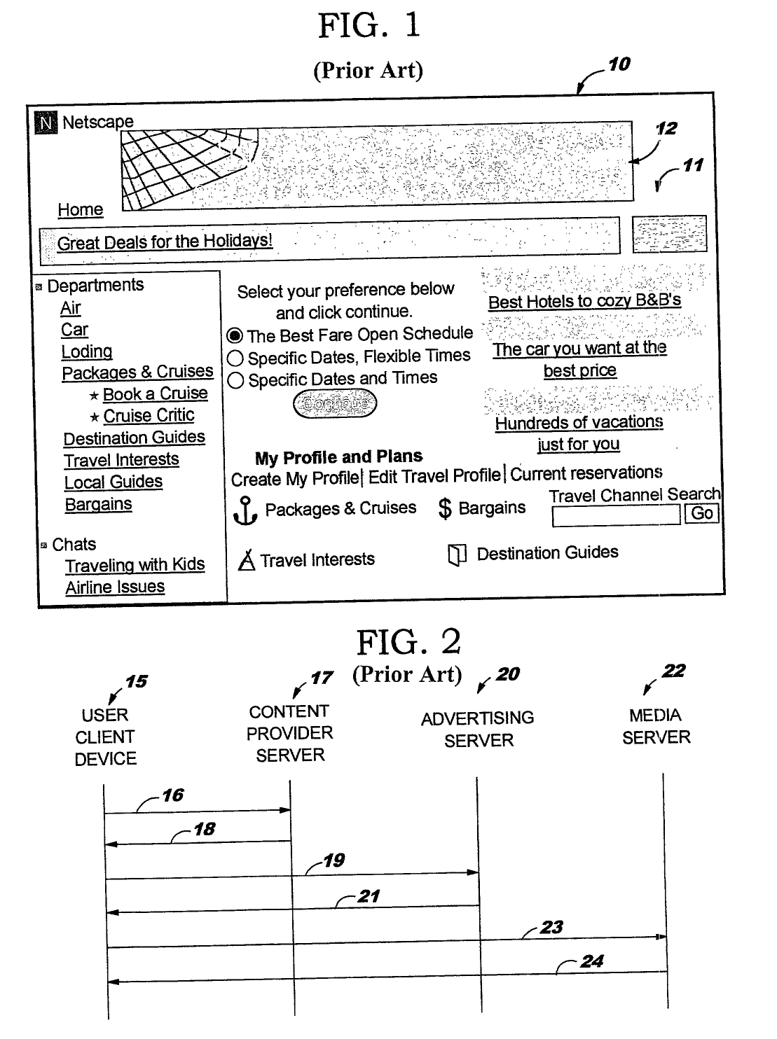

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, the present invention may be embodied as methods, data processing systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including, but not limited to, hard disks, CD-ROMs, optical storage devices, and magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C”, or in various other programming languages. Software embodiments of the present invention do not depend on implementation with a particular programming language. In addition, portions of the program code may execute entirely on one or more data processing systems.

In addition, portions of computer program code may execute entirely on one or more data processing systems. For example, program code for carrying out aspects of the present invention may execute entirely on a server, or may execute partly on a server and partly on a client within a client device (i.e., a user's Web client), or as a proxy server at an intermediate point in a communications network. In the latter scenario, a client device may be connected to a server through a LAN or a WAN (e.g., an intranet), or the connection may be made through the Internet (e.g., via an Internet Service Provider).

The present invention is described below with reference to block diagrams and/or flowchart illustrations of methods, apparatus (systems) and computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus,, create means for implementing the functions specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

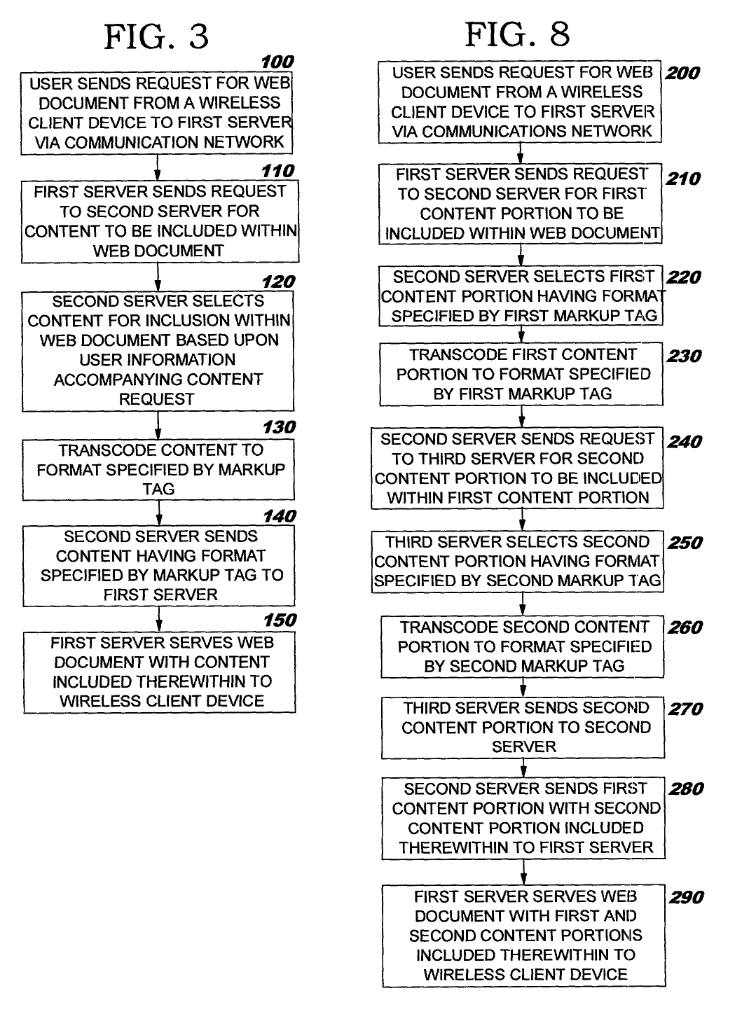

Referring now to FIG. 3, operations for dynamically inserting content into Web documents for display by wireless client devices, according to embodiments of the present invention, are illustrated. A user sends a request for a Web document from a wireless client device to a first server (e.g., a Web server), via a communications network (e.g., the Internet, an intranet, etc.) (Block 100). In response to receiving the user request, the first server sends a request to a second server (e.g., a third party ad server) for additional content (e.g., an advertisement, such as an image and/or text) to be included within the requested Web document (Block 110). The location of the additional content is identified within the Web document by one or more markup tags. Additional information, such as the format of the content, may be specified by the markup tag(s) as well.

Exemplary wireless client devices that may be utilized with embodiments of the present invention include, but are not limited to, personal digital assistants (PDAs), portable computers, hand-held computers, cellular telephones, web phones, web-enabled radiotelephones, and the like. Embodiments of the present invention may cover the use of these devices in both an online “live” mode and an offline “sync” mode that is used by many PDAs. Browsers running on a wireless client device may communicate with a Web server via communications networks, including the Internet, wide area networks, private networks (e.g., intranets), cellular radiotelephone networks and/or satellite radiotelephone networks.

A markup language is a set of characters or other symbols that are inserted within a document to indicate how the document should look when it is printed or displayed or to describe the document's logical structure. The characters or other symbols are referred to as “markup tags.” HTML (HyperText Markup Language), XML (Extensible Markup Language), VXML (Voice Extensible Markup Language), WML (Wireless Markup Language), and HDML (Handheld Device Markup Language) are exemplary markup languages that utilize markup tags. Markup languages, such as HTML, HDML, WML, XML, and VXML, and their respective tags, are well known to those of skill in the art, and need not be described further herein.

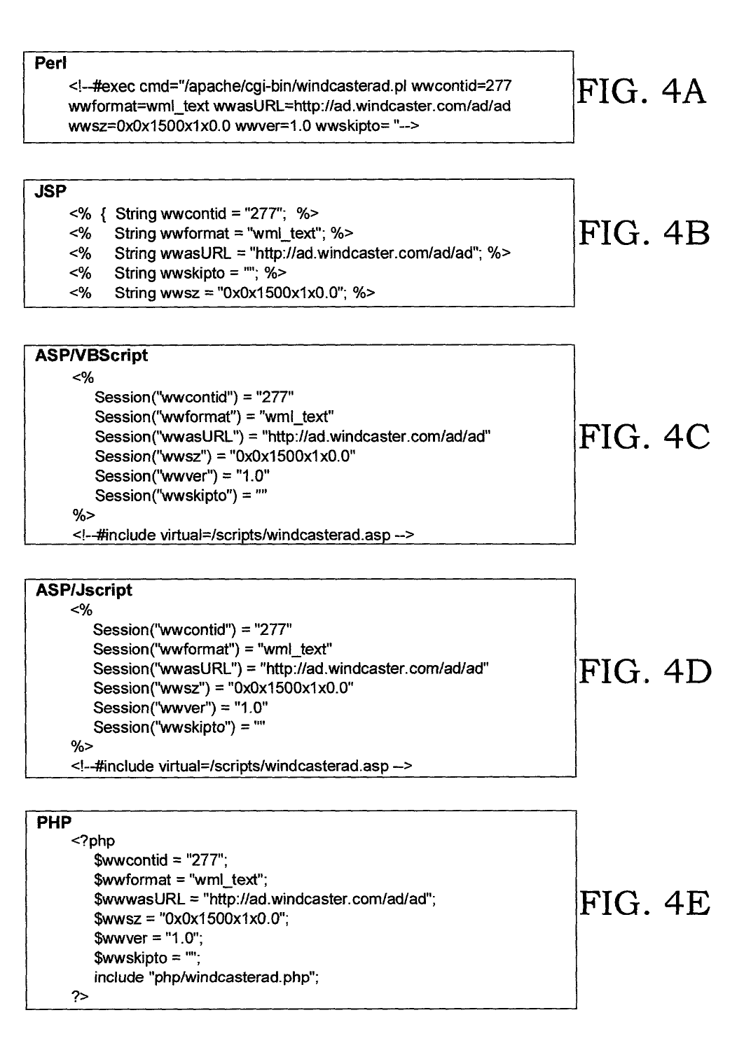

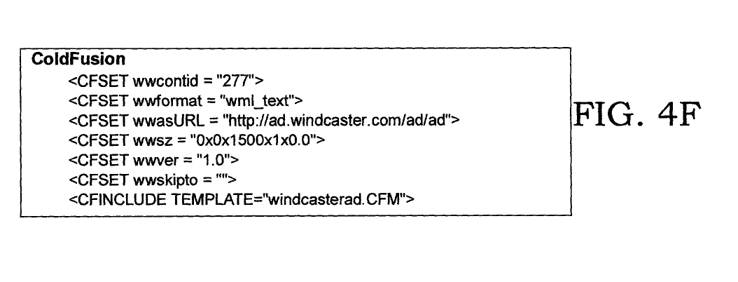

Markup tags utilized in accordance with embodiments of the present invention may be associated with various dynamic Web serving technologies including, but not limited to, Perl, Cold Fusion, ASP (Active Server Pages), JavaScript, VBScript, PHP (Personal Home Page tools scripting language), and JSP (Java Server Pages). FIGS. 4A-4F illustrate exemplary markup tags for various dynamic Web server technologies that may be utilized in accordance with embodiments of the present invention.

The content request sent to the second server may include any information that was received with the user request or that can be provided by the first server. For example, the user request may include information contained within a cookie stored within the user's wireless client device. In addition, a user request may include information contained within HTTP headers associated with the user request. The second server may select content for inclusion within the Web document based upon user information accompanying the content request (Block 120, FIG. 3).

Content selected by the second server for inclusion with the Web document may not have the format specified by the markup tag(s) within the Web document. The second server may be configured to transcode the additional content to the format specified by the markup tag(s) (Block 130). Web content transcoding is well known to those of skill in the art, and need not be described further herein.

The second server sends content having a format specified by the markup tag to the first server (Block 140). The first server then serves the Web document to the wireless client device with the additional content included therewithin at the identified location (Block 150).

Content inserted within a Web document in accordance with embodiments of the present invention may have various formats. For example, content format image files, text files, video files, audio files, executable scripts, and the like.

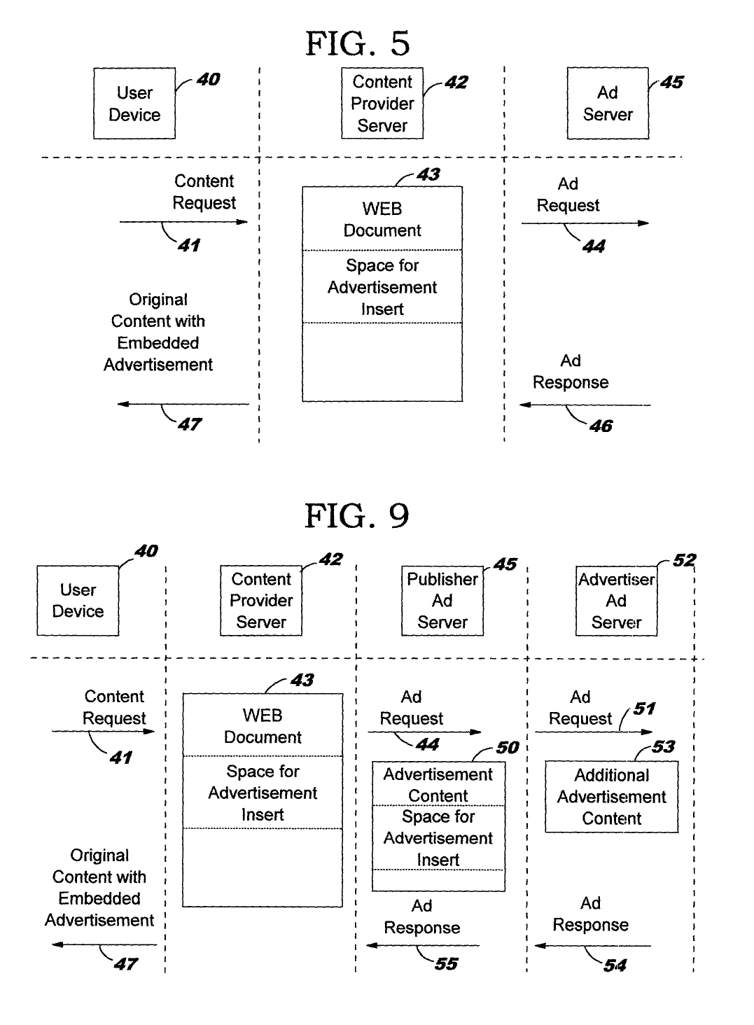

Referring now to FIG. 5, a block diagram representing systems, methods and/or computer program products for implementing the various operations of FIG. 3 is illustrated. A wireless user device 40 sends a content request 41 (i.e., a request for a Web document 43) to a content provider server 42. Within the Web document are one or more markup tags associated with one of various dynamic Web serving technologies including, but not limited to, Perl, Cold Fusion, PHP, JavaScript, VBScript, ASP, and JSP. In the illustrated embodiment, the markup tag(s) identifies a location within the Web document for an advertisement.

The presence of the markup tag(s) in the requested Web document 43 causes the content provider server 42 to send a request 44 to an ad server 45 (e.g., a third party ad server) for an advertisement to be inserted within the Web document 43 at the identified location. The ad server 45 selects an advertisement having a format specified by the markup tag in the Web document 43. Alternatively, the ad server 45 is configured to transcode an advertisement having a non-conforming format into the specified format. In addition, the ad server 45 may select an advertisement based upon information about the user making the request for the Web document 43. This user information may be sent with the request for the advertisement.

The ad server 45 sends a response 46 containing the selected advertisement to the content provider server 42. The content provider server 42 inserts the advertisement within the Web document 43 at the identified location and then serves the Web document and embedded advertisement (collectively indicated as 47) to the requesting user device 40 for display.

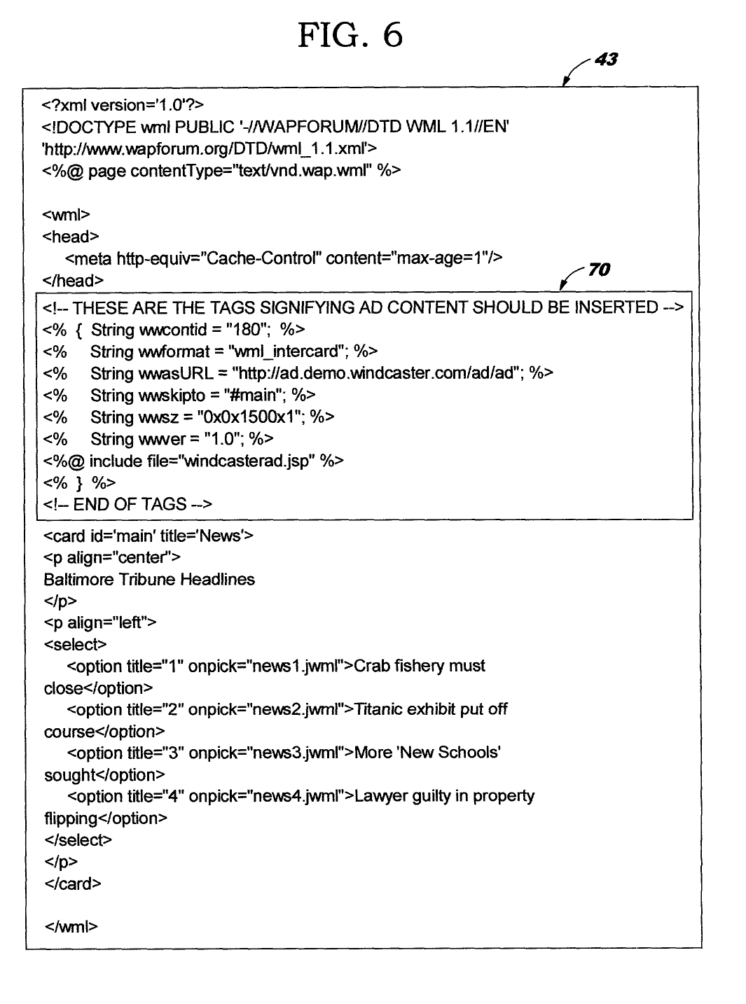

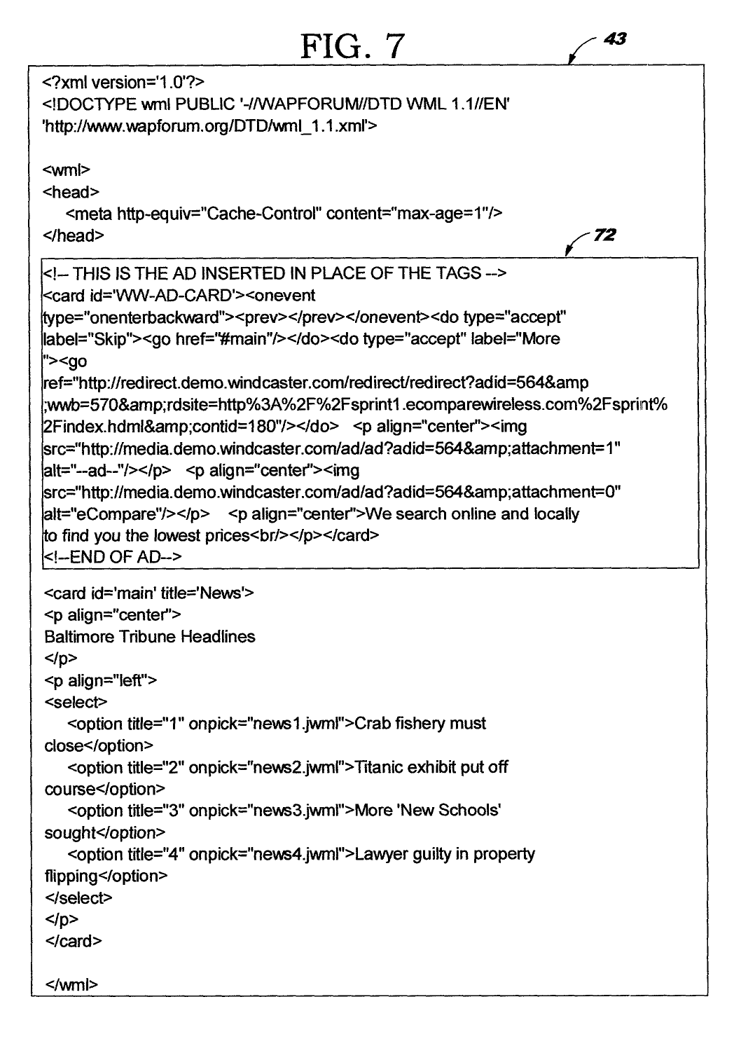

FIG. 6 illustrates an exemplary Web document 43 in WML format that contains a plurality of markup tags 70 that indicate the location and format of additional content to be included within the Web document 43. FIG. 7 illustrates the Web document 43 of FIG. 6 after advertisement content 72 has been dynamically inserted in place of the various markup tags 70 (FIG. 6). The Web document 43 of FIG. 7 is ready to be served to a user client device for display.

Referring now to FIG. 8, operations for dynamically inserting content into Web documents for display by a wireless client device, according to additional embodiments of the present invention, are illustrated. A user sends a request for a Web document from a wireless client device to a first server (e.g., a Web server), via a communications network (e.g., the Internet, an intranet, etc.) (Block 200). In response to receiving the user request, the first server sends a request to a second server for a first content portion (e.g., an advertisement, such as an image and/or text) to be included within the requested Web document (Block 210). The location of the first content portion is identified within the Web document by one or more first markup tags. In addition, the format of the first content portion is specified by the one or more first markup tags.

In response to receiving the request for the first content portion, the second server selects a first content portion having a format specified by the first markup tag(s) (Block 220). If a first content portion does not have a format specified by the first markup tag(s), a first content portion may be transcoded to the format specified by the first markup tag(s) (Block 230). Transcoding may be performed by the second server or by a data processing system in communication with the second server, as would be understood by one of skill in the art.

The content selected by the second server may itself include some markup tags that indicate to the second server that additional requests are required. In this case, the second server sends a request to a third server (e.g., a third party server) for a second content portion to be included within the first content portion at a location identified within the first content portion by one or more second markup tags (Block 240). The second server may pass along information about the original user request (cookies, user information, headers, etc.) to the third server. Accordingly, the third server may be able to perform targeting and personalization as accurately as the second server.

In response to receiving the request for the second content portion, the third server selects a second content portion having a format specified by the second markup tag(s) (Block 250). If a second content portion does not have a format specified by the second markup tag(s), a second content portion may be transcoded to the format specified by the second markup tag(s) (Block 260). Transcoding may be performed by the third server or by a data processing system in communication with the third server, as would be understood by one of skill in the art.

The third server then sends the second content portion to the second server (Block 270). The second server sends the first content portion with the second content portion included therewithin to the first server (Block 280). The first server then serves the Web document to the wireless client device with the first and second content portions included therewithin at the identified location (Block 290).

Referring now to FIG. 9, a block diagram representing systems, methods and/or computer program products for implementing the various operations of FIG. 8 in the context of ad serving is illustrated. A wireless user device 40 sends a content request 41 (i.e., a request for a Web document 43) to a content provider server 42. Within the Web document 43 is a markup tag (or tags) associated with one of various dynamic Web serving technologies including, but not limited to, HTML, WML, VXML, Perl, Cold Fusion, JavaScript, VBScript, ASP, PHP, and JSP. In the illustrated embodiment, the markup tag identifies a location within the Web document 43 for an advertisement.

The presence of the markup tag in the requested Web document 43 causes the content provider server 42 to send a request 44 to an publisher ad server 45 for advertisement content 50 to be inserted within the Web document 43 at the identified location. The publisher ad server 45 selects advertisement content 50 having a format specified by the markup tag in the Web document 43. Alternatively, the publisher ad server 45 is configured to transcode advertisement content having a non-conforming format into the specified format. In addition, the publisher ad server 45 may select advertisement content based upon any information (e.g., user information) that was included with the request for the Web document. This user information may be sent with the request for the advertisement content 50, as described above.

Within the requested advertisement content 50 is another markup tag (or tags) associated with one of various dynamic Web serving technologies including, but not limited to, HTML, WML, VXML, Perl, Cold Fusion, JavaScript, VBScript, ASP, PHP, and JSP. Exemplary markup tags for various dynamic Web server technologies that may be utilized in accordance with various embodiments of the present invention are illustrated in FIGS. 4A-4F.

The markup tag within the advertisement content 50 identifies a location within the advertisement content 50 for additional content 53. The presence of the markup tag in the advertisement content 50 causes the publisher ad server 45 to send a request 51 to an advertiser ad server 52 for additional content 53 to be inserted within the advertisement content 50 at the identified location. The advertiser ad server 52 selects additional content 53 having a format specified by the markup tag in the advertisement content 50. Alternatively, the advertiser ad server 52 is configured to transcode additional content having a non-conforming format into the specified format. In addition, the advertiser ad server 52 may select additional content based upon information about the user making the request for the Web document, or based upon any information received with the user request. This user information may be sent with the request for the additional content.

The advertiser ad server 52 sends a response 54 containing the additional content to the publisher as server 45. The publisher ad server inserts the additional content 53 within the advertisement content 50 and sends a response 55 containing the advertisement content 50 (and additional content 53) to the content provider server 42. The content provider server 42 inserts the advertisement (the advertisement content 50 and additional advertisement content 53) within the Web document 43 and then serves the Web document and embedded advertisement (collectively indicated as 47) to the requesting user device 40 for display.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of dynamically inserting content into a Web document for display by a client device, the method comprising:
sending a user request for a Web document from a client device to a first server, via a communications network;
sending a request from the first server to a second server for content for inclusion within the Web document, wherein a location for the content is identified within the Web document by a markup tag, and wherein a format of the content is specified by the markup tag;
sending content having a format specified by the markup tag from the second server to the first server; and
serving the Web document with the content included therewithin at the identified location to the client device.

2. The method according to claim 1, wherein the client device comprises a wireless client device.

3. The method according to claim 1, wherein the content request includes information about the user, and wherein the step of sending content to the first server further comprises sending content targeted for the user based upon the user information.

4. The method according to claim 1, further comprising the step of transcoding the content to the format specified by the markup tag prior to sending the content to the first server.

5. The method according to claim 3, wherein the user information comprises information contained within a cookie stored within the wireless client device.

6. The method according to claim 3, wherein the user information comprises information contained within one or more HTTP headers associated with the user request.

7. The method according to claim 1, wherein the content comprises content selected from the group consisting of advertisements, promotions, coupons, and dynamic content.

8. The method according to claim 2, wherein the wireless client device is selected from the group consisting of radiotelephones, personal digital assistants, and pagers.

9. A met hod of dynamically inserting content into a Web document for display by a client device, the method comprising:
sending a user request for a Web document from a client device to a first server, via a communications network;
sending a request from the first server to a second server for content for inclusion within the Web document, wherein a location for the content is identified within the Web document by a markup tag, wherein a format of the content is specified by the markup tag, and wherein the content request includes information about the user;
selecting content for inclusion within the Web document based upon the user information;
transcoding the selected content to a format specified by the markup tag;
sending the selected, transcoded content to the first server, and;
serving the Web document with the selected, transcoded content included therewithin at the identified location to the client device.

10. The method according to claim 9, wherein the client device comprises a wireless client device.

11. The method according to claim 9, wherein the user information comprises information contained within a cookie stored within the client device.

12. The method according to claim 9, wherein the user information comprises information contained within one or more HTTP headers associated with the user request.

13. The method according to claim 9, wherein the content comprises content selected from the group consisting of advertisements, promotions, coupons, and dynamic content.

14. The method according to claim 10, wherein the wireless client device is selected from the group consisting of radiotelephones, personal digital assistants, and pagers.

15. A method of dynamically inserting content into a Web document for display by a wireless client device, the method comprising:
sending a user request for a Web document from a wireless client device to a first server, via a communications network;
sending a request from the first server to a second server for a first content portion for inclusion within the Web document, wherein a location for the first content portion is identified within the Web document by a first markup tag, and wherein a format of the first content portion is specified by the first markup tag;
sending a request from the second server to a third server for a second content portion for inclusion within the first content portion, wherein a location for the second content portion is identified within the first content portion by a second markup tag, and wherein a format of the second content portion is specified by the second markup tag;
selecting a second content portion having a format specified by the second markup tag;
sending the selected second content portion to the second server;
sending the first content portion with the second content portion included therewithin to the first server; and
serving the Web document with the first and second content portions included therewithin to the wireless client device.

16. The method according to claim 15, further comprising the step of transcoding the first content portion to the format specified by the first markup tag prior to sending the first content portion to the first server.

17. The method according to claim 15, further comprising the step of transcoding the second content portion to the format specified by the second markup tag prior to sending the second content portion to the second server.

18. The method according to claim 15, wherein the content comprises content selected from the group consisting of advertisements, promotions, coupons, and dynamic content.

19. The method according to claim 15, wherein the wireless client device is selected from the group consisting of radiotelephones, personal digital assistants, and pagers.

20. A system for dynamically inserting content into a Web document for display by a client device, comprising:
means for sending a user request for a Web document from a client device to a first server, via a communications network;
means for sending a request from the first server to a second server for content for inclusion within the Web document, wherein a location for the content is identified within the Web document by a markup tag, and wherein a format of the content is specified by the markup tag;
means for sending content having a format specified by the markup tag from the second server to the first server; and
means for serving the Web document with the content included therewithin at the identified location to the client device.

21. The system according to claim 20, wherein the client device comprises a wireless client device.

22. The system according to claim 20, wherein the content request includes information about the user, and wherein the means for sending content to the first server further comprises means for sending content targeted for the user based upon the user information.

23. The system according to claim 20, further comprising means for transcoding the content to the format specified by the markup tag prior to sending the content to the first server.

24. The system according to claim 22, wherein the user information comprises information contained within a cookie stored within the wireless client device.

25. The system according to claim 22, wherein the user information comprises information contained within one or more HTTP headers associated with the user request.

26. The system according to claim 20, wherein the content comprises content selected from the group consisting of advertisements, promotions, coupons, and dynamic content.

27. The system according to claim 21, wherein the wireless client device is selected from the group consisting of radiotelephones, personal digital assistants, and pagers.

28. A system for dynamically inserting content into a Web document for display by a client device, comprising:
means for sending a user request for a Web document from a client device to a first server, via a communications network;
means for sending a request from the first server to a second server for content for inclusion within the Web document, wherein a location for the content is identified within the Web document by a markup tag, wherein a format of the content is specified by the markup tag, and wherein the content request includes information about the user;
means for selecting content for inclusion within the Web document based upon the user information;
means for transcoding the selected content to a format specified by the markup tag;
means for sending the selected, transcoded content to the first server; and
means for serving the Web document with the selected, transcoded content included therewithin at the identified location to the client device.

29. The system according to claim 28, wherein the client device comprises a wireless client device.

30. The system according to claim 28, wherein the user information comprises information contained within a cookie stored within the client device.

31. The system according to claim 28, wherein the user information comprises information contained within one or more HTTP headers associated with the user request.

32. The system according to claim 28, wherein the content comprises content selected from the group consisting of advertisements, promotions, coupons, and dynamic content.

33. The system according to claim 29, wherein the wireless client device is selected from the group consisting of radiotelephones, personal digital assistants, and pagers.

34. A system for dynamically inserting content into a Web document for display by a wireless client device, comprising:
means for sending a user request for a Web document from a wireless client device to a first server, via a communications network;
means for sending a request from the first server to a second server for a first content portion for inclusion within the Web document, wherein a location for the first content portion is identified within the Web document by a first markup tag, and wherein a format of the first content portion is specified by the first markup tag;
means for sending a request from the second server to a third server for a second content portion for inclusion within the first content portion, wherein a location for the second content portion is identified within the first content portion by a second markup tag, and wherein a format of the second content portion is specified by the second markup tag;
means for selecting a second content portion having a format specified by the second markup tag;
means for sending the selected second content. portion to the second server;
means for sending the first content portion with the second content portion included therewithin to the first server; and
means for serving the Web document with the first and second content portions included therewithin to the wireless client device.

35. The system according to claim 34, further comprising means for transcoding the first content portion to the format specified by the first markup tag prior to sending the first content portion to the first server.

36. The system according to claim 34, further comprising means for transcoding the second content portion to the format specified by the second markup tag prior to sending the second content portion to the second server.

37. The system according to claim 34, wherein the content comprises content selected from the group consisting of advertisements, promotions, coupons, and dynamic content.

38. The system according to claim 34, wherein the wireless client device is selected from the group consisting of radiotelephones, personal digital assistants, and pagers.

39. A computer program product for dynamically inserting content into a Web document for display by a client device, the computer program product comprising a computer usable storage medium having computer readable program code embodied in the medium, the computer readable program code comprising:
computer readable program code that sends a user request for a Web document from a client device to a first server, via a communications network;
computer readable program code that sends a request from the first server to a second server for content for inclusion within the Web document, wherein a location for the content is identified within the Web document by a markup tag, and wherein a format of the content is specified by the markup tag;
computer readable program code that sends content having a format specified by the markup tag from the second server to the first server; and
computer readable program code that serves the Web document with the content included therewithin at the identified location to the client device.

40. The computer program product according to claim 39, wherein the client device comprises a wireless client device.

41. The computer program product according to claim 39, wherein the content request includes information about the user, and wherein the computer readable program code that sends content to the first server further comprises computer readable program code that sends content targeted for the user based upon the user information.

42. The computer program product according to claim 39, further comprising computer readable program code that transcodes the content to the format specified by the markup tag prior to sending the content to the first server.

43. The computer program product according to claim 41, wherein the user information comprises information contained within a cookie stored within the wireless client device.

44. The computer program product according to claim 41, wherein the user information comprises information contained within one or more HTTP headers associated with the user request.

45. The computer program product according to claim 39, wherein the content comprises content selected from the group consisting of advertisements, promotions, coupons, and dynamic content.

46. The computer program product according to claim 40, wherein the wireless client device is selected from the group consisting of radiotelephones, personal digital assistants, and pagers.

47. A computer program product for dynamically inserting content into a Web document for display by a client device, the computer program product comprising a computer usable storage medium having computer readable program code embodied in the medium, the computer readable program code comprising:
computer readable program code that sends a user request for a Web document from a client device to a first server, via a communications network;
computer readable program code that sends a request from the first server to a second server for content for inclusion within the Web document, wherein a location for the content is identified within the Web document by a markup tag, wherein a format of the content is specified by the markup tag, and wherein the content request includes information about the user;
computer readable program code that selects content for inclusion within the Web document based upon the user information;
computer readable program code that transcodes the selected content to a format specified by the markup tag;
computer readable program code that sends the selected, transcoded content to the first server; and
computer readable program code that serves the Web document with the selected, transcoded content included therewithin at the identified location to the client device.

48. The computer program product according to claim 47, wherein the client device comprises a wireless client device.

49. The computer program product according to claim 47, wherein the user information comprises information contained within a cookie stored within the client device.

50. The computer program product according to claim 47, wherein the user information comprises information contained within one or more HTTP headers associated with the user request.

51. The computer program product according to claim 47, wherein the content comprises content selected from the group consisting of advertisements, promotions, coupons, and dynamic content.

52. The computer program product according to claim 48, wherein the wireless client device is selected from the group consisting of radiotelephones, personal digital assistants, and pagers.

53. A computer program product for dynamically inserting content into a Web document for display by a wireless client device, the computer program product comprising a computer usable storage medium having computer readable program code embodied in the medium, the computer readable program code comprising:
computer readable program code that sends a user request for a Web document from a wireless client device to a first server, via a communications network;
computer readable program code that sends a request from the first server to a second server for a first content portion for inclusion within the Web document, wherein a location for the first content portion is identified within the Web document by a first markup tag, and wherein a format of the first content portion is specified by the first markup tag;
computer readable program code that sends a request from the second server to a third server for a second content portion for inclusion within the first content portion, wherein a location for the second content portion is identified within the first content portion by a second markup tag, and wherein a format of the second content portion is specified by the second markup tag;
computer readable program code that selects a second content portion having a format specified by the second markup tag;
computer readable program code that sends the selected second content portion to the second server;
computer readable program code that sends the first content portion with the second content portion included therewithin to the first server; and
computer readable program code that serves the Web document with the first and second content portions included therewithin to the wireless client device.

54. The computer program product according to claim 53, further comprising computer readable program code that transcodes the first content portion to the format specified by the first markup tag prior to sending the first content portion to the first server.

55. The computer program product according to claim 53, further comprising computer readable program code that transcodes the second content portion to the format specified by the second markup tag prior to sending the second content portion to the second server.

56. The computer program product according to claim 53, wherein the content comprises content selected from the group consisting of advertisements, promotions, coupons, and dynamic content.

57. The computer program product according to claim 53, wherein the wireless client device is selected from the group consisting of radiotelephones, personal digital assistants, and pagers.
